(19) United States
(12) Patent Application Publication
(10) Pub. No.: US 2026/0299093 A1
(43) Pub. Date: Oct. 1, 2026

(54) LIDAR MOTOR AND LIDAR

(71) Applicant: TUDATONG (SUZHOU) CO., LTD., SUZHOU (CN)

(72) Inventors: Song XU, SUZHOU (CN); Qi HAN, SUZHOU (CN); Long MENG, SUZHOU (CN)

(73) Assignee: TUDATONG (SUZHOU) CO., LTD., SUZHOU, JS (CN)

(21) Appl. No.: 19/629,663

(22) Filed: Mar. 26, 2026

(30) Foreign Application Priority Data
Mar. 26, 2025 (CN) 202520547903.5

(51) Int. Cl. G01S 7/481

(52) U.S. Cl. CPC G01S 7/4817

(57) ABSTRACT

The present disclosure provides a Lidar motor. The Lidar motor includes: a rotating body, having a plurality of side surfaces for redirecting light beams; a stator assembly, including a central shaft connected at one end to the rotating body, where the stator assembly drives the rotating body to rotate via the central shaft; and a bearing assembly, including at least one bearing sleeved on one end of the central shaft. The Lidar motor according to an embodiment of the present disclosure replaces a lens core and a motor housing in the related art with the rotating body, thereby reducing the number of components in the Lidar motor. In addition, the Lidar motor according to the embodiment of the present disclosure further reduces a total runout error of an outer edge of the motor and lowers the assembly cost and overall cost of the Lidar motor.

### TECHNICAL FIELD

The present disclosure relates to the technical field of Lidar, and in particular, to a Lidar motor and a Lidar.

### BACKGROUND

With the rapid development of technologies such as intelligent driving, Lidar is attracting increasing attention, and its applications are showing a trend of explosive growth. At present, the rotation of an optical reflective mirror of a Lidar is usually driven by a motor with an outer rotor, that is, a lens core and a motor housing are fixed by a pressing cap and press-fit rubber such that the optical reflective mirror rotates synchronously with the outer rotor of the motor.

However, Lidar motors in the related art usually have problems such as complex design, numerous components, large cumulative tolerances that make accuracy difficult to ensure, and high cost.

The methods described in this section are not necessarily those that have been previously envisioned or adopted. Unless otherwise indicated, none of the methods described in this section should be assumed to be the prior art merely because they are included in this section. Similarly, unless otherwise indicated, the problems mentioned in this section should not be considered as having been recognized in any prior art.

### SUMMARY

The present disclosure is intended to solve at least one of the technical problems existing in the background. In view of this, an objective of the present disclosure is to provide a Lidar motor and a Lidar.

According to a first aspect of an embodiment of the present disclosure, there is provided a Lidar motor. The Lidar motor includes: a rotating body, having a plurality of side surfaces for redirecting light beams; a stator assembly, including a central shaft connected at one end to the rotating body, where the stator assembly drives the rotating body to rotate via the central shaft; and a bearing assembly, including at least one bearing sleeved on one end of the central shaft.

According to a second aspect of an embodiment of the present disclosure, there is provided a Lidar. The Lidar includes the Lidar motor according to the first aspect above.

The Lidar motor according to the embodiment of the present disclosure replaces a lens core and a motor housing in the related art with the rotating body, thereby reducing the number of components in the Lidar motor. In addition, the Lidar motor according to the embodiment of the present disclosure further reduces a total runout error of an outer edge of the motor and lowers the assembly cost and overall cost of the Lidar motor.

### BRIEF DESCRIPTION OF THE DRAWINGS

The drawings exemplarily illustrate embodiments and constitute part of the specification, and together with the textual description of the specification, serve to illustrate exemplary implementations of the embodiments. The embodiments shown are for illustrative purposes only and do not limit the scope of claims. In all the drawings, the same reference numerals refer to the same elements or similar but not necessarily identical elements.

FIG. 1 shows a schematic diagram of a Lidar motor in the related art;

FIG. 2 shows a schematic diagram of a Lidar motor according to an embodiment of the present disclosure; and

FIG. 3 shows a schematic diagram of a Lidar motor according to an embodiment of the present disclosure.

### Description of Reference Signs

110: lens core; 120: housing; 130: rubber flat washer; 140: locking ring; 150: pressing cap;
210: rotating body; 220: stator assembly; 230: bearing assembly; 240: base plate; 250: washer; 260: snap ring; 270: integrated flexible circuit board;
212: side surface; 214: weight-reducing annular groove; 216: bottom surface; 222: central shaft;
232: lower bearing; and 234: upper bearing.

### DETAILED DESCRIPTION OF THE EMBODIMENTS

A further detailed description of the present disclosure will be provided below in conjunction with the drawings and embodiments. It can be understood that the specific embodiments described herein are merely to illustrate the related invention, and are not intended to limit the invention. Additionally, it should be noted that for ease of description, only parts related to the related invention are shown in the drawings.

It should be noted that the embodiments of the present disclosure and the features in the embodiments may be combined with each other without conflict. Unless otherwise explicitly stated in the context, if the number of elements is not specifically limited, the element can be one or plural. In addition, the numbers of steps or functional modules used in the present disclosure are only used to identify each step or functional module, and are not used to limit the execution order of each step or the connection relationship between each functional module.

In the present disclosure, unless otherwise specified, the use of the terms “first”, “second”, etc. to describe various elements is not intended to define the positional relationship, temporal relationship, or importance relationship of these elements, and such terms are simply used to distinguish one element from another element. In some examples, the first element and the second element may refer to the same instance of the element, while in some cases, they may also refer to different instances based on contextual descriptions.

In the present disclosure, the terms used in the description of various described examples are for the purpose of describing specific examples only, and are not intended to be limiting. Unless otherwise explicitly stated in the context, if the number of elements is not specifically limited, the element can be one or plural. In addition, the term “and/or” used in the present disclosure encompasses any one and all possible combinations of the listed items.

As described above, in the Lidar motor of the related art, synchronous rotation of the optical reflective mirror and the outer rotor of the motor can be achieved by fixing the lens core and the motor housing.

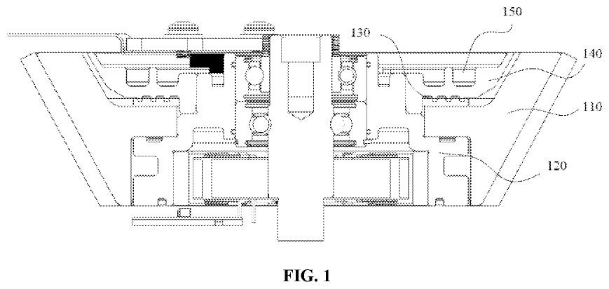

FIG. 1 shows a schematic diagram of a Lidar motor in the related art. Referring to FIG. 1, a process for the Lidar motor in the related art usually includes the following steps: first, assembling a housing 120, a lens core 110 of an optical reflective mirror, a rubber flat washer 130, and a locking ring 140 together, then pressing a pressing cap 150 and the locking ring 140 by using a servo press to fix the housing 120 and the lens core 110, and finally completing the product process via fixation by laser welding.

Due to a large number of assembly components in the Lidar motor of the related art, the following problems usually arise: the accumulation of manufacturing errors of the components and assembly errors between the components increases a total runout error of an outer edge of the motor (i.e., a maximum deviation of the outer edge of the motor during rotation), thereby affecting the accuracy of the Lidar; and the assembly cost and overall cost of the Lidar motor are increased. In addition, since the lens core and the motor housing in the related art are usually made of steel, this also results in excessive overall weight of the motor, making it difficult to adjust dynamic balance.

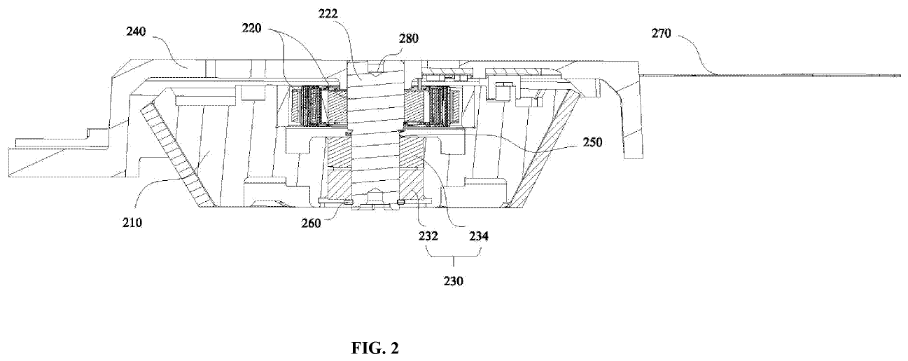

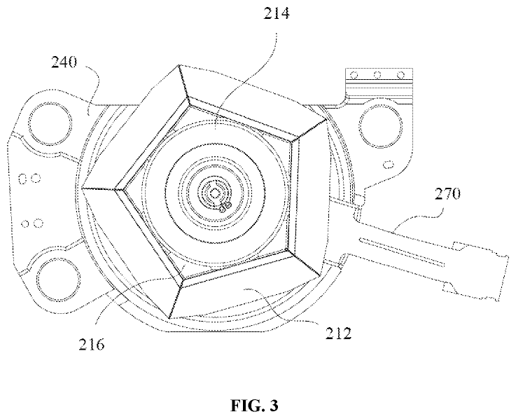

To at least solve or alleviate one of the technical problems existing in the related art described above, a first aspect of the present disclosure provides a Lidar motor. Reference is made to FIG. 2 and FIG. 3, which show schematic diagrams of a Lidar motor according to an embodiment of the present disclosure.

The Lidar motor includes: a rotating body 210, a stator assembly 220, and a bearing assembly 230. The rotating body 210 has a plurality of side surfaces 212 for redirecting light beams. The stator assembly 220 includes a central shaft 222 connected at one end to the rotating body 210. The stator assembly 220 drives the rotating body 210 to rotate via the central shaft 222. The bearing assembly 230 includes at least one bearing 234 sleeved on one end of the central shaft 222.

In the Lidar motor according to the embodiment of the present disclosure, the stator assembly 220 directly drives the rotating body 210 to rotate, and the plurality of side surfaces 212 of the rotating body 210 can be guided to redirect light toward the Lidar motor during rotation.

Differing from the related art in which synchronous rotation of the optical reflective mirror and the outer rotor of the motor is achieved by fixing the motor housing and the lens core, the Lidar motor according to the embodiment of the present disclosure integrates the motor housing and the lens core into the rotating body. This arrangement not only eliminates the components such as the rubber flat washer, the locking ring, and the pressing cap, but also reduces the total runout error of the outer edge of the motor, and lowers the assembly cost and overall cost of the Lidar motor.

In some embodiments, the rotating body 210 may be formed in a shape of a truncated pyramid, and has a top surface (not shown in the figures), a bottom surface 216, and a plurality of side surfaces 212. The rotating body 210 may have a top surface and a bottom surface in a polygonal shape (e.g., a pentagonal shape, a hexagonal shape, an octagonal shape, etc.) and a plurality of side surfaces 212 in a wedge shape (e.g., a trapezoidal shape). The side surfaces may have a first inclination angle. In the present disclosure, the “inclination angle” refers to an angle between a normal direction of the side surfaces and a rotation axis of the rotating body. The first inclination angle may be, for example, 30°, 45°, or 60°, depending on actual needs, such as a relative positional relationship between the Lidar motor and other optical redirection components in the Lidar, or a mounting position of the Lidar motor, and is not intended to be limited herein.

In some embodiments, the side surfaces 212 may be coated surfaces. For example, a coating process (e.g., aluminum coating) may be performed on the side surfaces 212 of the rotating body 210 such that the rotating body has reflective surfaces. In some other embodiments, reflective mirrors may also be adhesively fixed to the side surfaces 212. Thus, when the rotating body 210 is driven by the central shaft to rotate, the side surfaces 212 of the rotating body 210 reflect the light in turn, thereby achieving scanning of the light beams in one dimension (e.g., a horizontal dimension).

In some embodiments, the bearing assembly 230 may include at least one bearing 232. It should be understood that the number of bearings may depend on actual needs. Referring to the example shown in FIG. 2, the bearing assembly 230 may include two bearings, namely, a lower bearing 232 and an upper bearing 234. The lower bearing 232 and the upper bearing 234 are sequentially sleeved on one end of the central shaft 222, for example, sleeved on one end of the central shaft 222 close to the bottom surface 216 of the rotating body 210.

In some embodiments, the Lidar motor further includes a base plate 240 fixedly connected to the other end of the central shaft 222 via a fastener 280 (e.g., a screw). The other end of the central shaft 222 may be the end close to the top surface of the rotating body 210.

Referring to FIG. 2 and FIG. 3, the Lidar motor may further include an integrated flexible circuit board 270. The integrated flexible circuit board 270 may be attached to the base plate 240 and configured to provide electrical connections for devices such as a sensor and a controller in the Lidar motor. The sensor may be, for example, a position encoder (e.g., a rotary encoder or a Hall sensor) for detecting an angular position of the rotating body. In some embodiments, the integrated flexible circuit board 270 may further integrate UVW three-phase lines for driving the motor to operate, for example, both outlet positions of the UVW three-phase lines and an outlet position of the position encoder may be integrated on the integrated flexible circuit board 270.

By using the integrated flexible circuit board, the wiring complexity inside the motor can be reduced and the assembly process can be simplified. In addition, the integrated arrangement can reduce the number of connectors and wirings, thereby reducing the risk of failures caused by poor contact or connection failure.

In some embodiments, referring to FIG. 2, the Lidar motor further includes a washer 250. The washer 250 is located on a side of an end face of a bearing inner ring of the bearing 234 and in contact with the end face of the bearing inner ring, and is configured to provide an axial preload force for the bearing assembly 230. The washer 250 may be, for example, a wave spring washer.

In some embodiments, a side of the central shaft 222 away from the base plate 240 is provided with a groove (not shown in the figure). With continued reference to FIG. 2, the Lidar motor further includes a snap ring 260 mounted in the groove and in contact with the end face of the bearing inner ring of the bearing 232.

In some embodiments, the central shaft 222 may be a two-step shaft, and there is a gap between the lower bearing 232 and the central shaft 222 and between the upper bearing 234 and the central shaft 222. Since the washer 250 and the snap ring 260 are disposed, movement of the shaft can be prevented by a friction force between the bearing inner ring and the central shaft, and the axial preload force will not be affected even if the lower bearing 232 and the upper bearing 234 are not fixed to the central shaft 222 by means of adhesive dispensing or the like.

By disposing the washer and the snap ring, and adopting a loose fit between the bearing and the central shaft, the assembly process of the Lidar motor can be further simplified. Compared with the method of pressing with the servo press and fixing by laser welding in the related art, the structural arrangement of the Lidar motor according to the embodiment of the present disclosure makes it easier to assemble and disassemble the motor, and therefore the reuse rate of the components in the motor can also be increased. During production, assembly, or use, after a motor that does not meet quality standards or has a defect is detected, unqualified components can be easily replaced without scrapping the entire motor.

In some embodiments, the lower bearing 232 and the upper bearing 234 may be adhesively fixed to the rotating body 210, and the side surfaces 212 of the rotating body 210 may be adhesively fixed (e.g., by means of adhesive dispensing) to the reflective mirrors arranged thereon to form a tight fit, thereby better managing and controlling noise, vibration, and harshness.

In some embodiments, referring to FIG. 3, a top and/or a bottom of the rotating body 210 may be provided with a weight-reducing annular groove 214. An unbalanced rotor will cause vibration of the motor during high-speed rotation, thereby affecting the scanning accuracy of the Lidar. Meanwhile, the vibration will be transmitted to the motor housing and surrounding structures, resulting in noise. Therefore, the Lidar motor can be balanced by forming the weight-reducing annular groove in the rotating body by means of, for example, laser weight reduction or the like, thereby effectively reducing the vibration and noise, and improving the performance and service life of the motor.

In some embodiments, the rotating body 210 may be integrally formed of metal. For example, the rotating body may be formed by injection molding using aluminum, or by turning, milling, or the like. The use of aluminum can reduce the overall weight of the motor and improve the dynamic balance adjustment capability of the motor.

The present disclosure further provides a Lidar, including the Lidar motor according to any one of the embodiments above.

Since the Lidar includes the Lidar motor according to any one of the embodiments above, the Lidar has the technical effects of the Lidar motor described above, which will not be repeated herein.

The following describes some exemplary solutions of the present disclosure.

Solution 1. A Lidar motor, including:
a rotating body, having a plurality of side surfaces for redirecting light beams;
a stator assembly, including a central shaft connected at one end to the rotating body, where the stator assembly drives the rotating body to rotate via the central shaft; and
a bearing assembly, including at least one bearing sleeved on one end of the central shaft.

Solution 2. The Lidar motor according to Solution 1, further including:
a base plate, fixedly connected to the other end of the central shaft via a fastener.

Solution 3. The Lidar motor according to Solution 2, further including:
a washer, located on a side of an end face of a bearing inner ring of one of the at least one bearing close to the base plate and in contact with the end face of the bearing inner ring.

Solution 4. The Lidar motor according to Solution 2, where a side of the central shaft away from the base plate is provided with a groove, and the Lidar motor further includes a snap ring mounted in the groove and in contact with the end face of the bearing inner ring of one of the at least one bearing.

Solution 5. The Lidar motor according to Solution 2, further including an integrated flexible circuit board, attached to the base plate and configured to provide an electrical connection for a sensor and a controller in the Lidar motor.

Solution 6. The Lidar motor according to any one of Solutions 1 to 5, where the rotating body is formed in a shape of a truncated pyramid, and the side surfaces have a first inclination angle, where the first inclination angle is an angle between a normal direction of the side surfaces and a rotation axis of the rotating body.

Solution 7. The Lidar motor according to any one of Solutions 1 to 6, where
the side surfaces are coated surfaces, or
the side surfaces are provided with reflective mirrors.

Solution 8. The Lidar motor according to any one of Solutions 1 to 7, where there is a gap between the at least one bearing and the central shaft, and the at least one bearing is adhesively fixed to the rotating body.

Solution 9. The Lidar motor according to any one of Solutions 1 to 8, where the central shaft is a two-step shaft.

Solution 10. The Lidar motor according to any one of Solutions 1 to 9, where a top and/or a bottom of the rotating body is provided with a weight-reducing annular groove.

Solution 11. The Lidar motor according to any one of Solutions 1 to 10, where the rotating body is integrally formed of metal.

Solution 12. The Lidar motor according to any one of Solutions 1 to 11, where the metal includes aluminum.

Solution 13. A Lidar, including: the Lidar motor according to any one of Solutions 1 to 12.

The above descriptions are only preferred embodiments of the present disclosure and explanations of the technical principles applied. Those skilled in the art should understand that the scope of the invention involved in the embodiments of the present disclosure is not limited to technical solutions formed by specific combinations of the above technical features, and should also cover other technical solutions formed by any combination of the above technical features or their equivalent features without departing from the above inventive concept, for example, technical solutions formed by mutually replacing the above features with (but not limited to) technical features with similar functions disclosed in the embodiments of the present disclosure.

1. A Lidar motor, comprising:
a rotating body, having a plurality of side surfaces for redirecting light beams;
a stator assembly, comprising a central shaft connected at one end to the rotating body, wherein the stator assembly drives the rotating body to rotate via the central shaft; and
a bearing assembly, comprising at least one bearing sleeved on one end of the central shaft.

2. The Lidar motor according to claim 1, further comprising:
a base plate, fixedly connected to the other end of the central shaft via a fastener.

3. The Lidar motor according to claim 2, further comprising:
a washer, located on a side of an end face of a bearing inner ring of one of the at least one bearing close to the base plate and in contact with the end face of the bearing inner ring.

4. The Lidar motor according to claim 2, wherein a side of the central shaft away from the base plate is provided with a groove, and the Lidar motor further comprises a snap ring mounted in the groove and in contact with the end face of the bearing inner ring of one of the at least one bearing.

5. The Lidar motor according to claim 2, further comprising an integrated flexible circuit board, attached to the base plate and configured to provide an electrical connection for a sensor and a controller in the Lidar motor.

6. The Lidar motor according to claim 1, wherein the rotating body is formed in a shape of a truncated pyramid, and the side surfaces have a first inclination angle,
wherein the first inclination angle is an angle between a normal direction of the side surfaces and a rotation axis of the rotating body.

7. The Lidar motor according to claim 6, wherein:
the side surfaces are coated surfaces, or the side surfaces are provided with reflective mirrors.

8. The Lidar motor according to claim 1, wherein:
there is a gap between the at least one bearing and the central shaft, and the at least one bearing is adhesively fixed to the rotating body.

9. The Lidar motor according to claim 8, wherein:
the central shaft is a two-step shaft.

10. The Lidar motor according to claim 1, wherein:
a top and/or a bottom of the rotating body is provided with a weight-reducing annular groove.

11. The Lidar motor according to claim 1, wherein:
the rotating body is integrally formed of metal.

12. The Lidar motor according to claim 11, wherein:
the metal comprises aluminum.

13. A Lidar, comprising:
the Lidar motor according to claim 1.
